(19) United States
(12) Patent Application Publication
(10) Pub. No.: US 2023/0281555 A1
(43) Pub. Date: Sep. 7, 2023

(54) UNDERGARMENT PACKAGING AND ORDER FULFILLMENT SYSTEM

(71) Applicant: Christina Zalch, Sacramento, CA (US)

(72) Inventor: Christina Zalch, Sacramento, CA (US)

(73) Assignee: Heaventech LLC, Sacramento, CA (US)

(21) Appl. No.: 18/115,768

(22) Filed: Mar. 1, 2023

Related U.S. Application Data
(60) Provisional application No. 63/315,466, filed on Mar. 1, 2022.

(51) Int. Cl. G06Q 10/0837; B65B 25/20; B65C 1/02; B65D 85/18; G06Q 10/087; G06Q 10/083; G06K 19/077

(52) U.S. Cl. CPC G06Q 10/0837; B65B 25/20; B65C 1/02; B65D 85/18; G06Q 10/087; G06Q 10/0838; G06K 19/07758

(57) ABSTRACT

A system for undergarment packaging and order fulfillment is provided comprising a computer and an application executing thereon that receives an online order for an undergarment from a mobile device or other electronic device, directs packaging of the online order comprising a flexible flat support component embedded in the undergarment and an external wrapper. The system also ships the undergarment in the wrapper, the wrapper placed inside a paper envelope. The paper envelope with its contents is shipped as letter mail under USPS DMM 101 letter mailing standards describing Machinable Criteria for Letters/letter shipping. The support component is a cardboard sheet with a rectangular or square shape and a bottom cutout to accommodate a lower part of the undergarment and to hold the undergarment in place, the cutout further comprising a semicircle void centered at a midpoint of a bottom edge.

### CROSS REFERENCE TO RELATED APPLICATIONS

The present non-provisional patent application is related to U.S. Provisional Patent Application No. 63/315,466 filed Mar. 1, 2022, the contents of which are incorporated herein in their entirety.

### FIELD OF THE DISCLOSURE

The present disclosure is in the field of packaging, shipping, and logistics. More particularly, the present disclosure provides systems and methods of packaging undergarments and other textile goods and subsequent order fulfillment, tracking, and distribution of said goods.

### BACKGROUND

Purchasing undergarments online in a non-bulk fashion is inconvenient and expensive due to the high cost of shipping and handling. This is a consequence of expensive traditional fulfillment systems and shipping methods used by conventional online retailers.

Based on high fulfillment and shipping fees relative to the low price of underpants, customers tend to buy underpants in bulk to dilute and reduce the impact of these fees. This dilemma limits the online purchase appeal of undergarments and discourages customers from purchasing single item undergarments. Furthermore, online shopping of undergarments is plagued with a high return rate which adds to the overall cost of sustaining a non-bulk undergarment business. As such, there is a need for an improved system that addresses these and related limitations.

### BRIEF DESCRIPTION OF THE FIGURES

FIG. 1 is a block diagram of an undergarment packaging and order fulfillment system according to an embodiment of the present disclosure.

FIG. 2 is an image of a shipping package bent angularly to test perpendicular flexibility at the end of the package according to embodiment of the present disclosure.

FIG. 3a through FIG. 3k are images of an undergarment packaging and order fulfillment system according to an embodiment of the present disclosure.

FIG. 4 is an image of an undergarment packaging and order fulfillment system according to an embodiment of the present disclosure.

### DETAILED DESCRIPTION

Systems and methods described herein provide a cost-effective packaging system and fulfillment method for the sale of low-cost undergarments that may include underwear, underpants, and panties. A flexible flat support is embedded in the undergarment along with an external wrapper to achieve compatibility with low-cost machinable letter mail as per USPS standards.

The disclosed packaging system is compatible with USPS Machinable Criteria for Letters/letter shipping. Such criteria may include avoiding unevenness of the letter package, which may be caused by loose items. To meet these criteria, the disclosed system utilizes an internal support, around which the underpants are wrapped. This prevents the underpants from bunching and creating bulges within the package.

Such underpants may comprise women's underwear or panties and/or undergarments that may fit tightly to the body. The undergarments may be made of a relatively thin material. The disclosed packaging may be utilized for other items, including, but not limited to various textile products and/or clothing.

The internal support/cardboard sheet may have a rectangular or square shape and may have a bottom cutout to accommodate a lower part of the undergarment and to hold the undergarment in place. The cutout may be a semicircle void which is centered at a midpoint of the bottom edge. The internal support surface of the packaging may include redeemable printed offers and coupons to be redeemed by the customer.

The system also utilizes an external wrap that may be a resealable polybag that holds the underpants within the internal support, and is compatible with USPS standards, for example USPS DMM 101 letter mailing standards for low-cost machinable letter mail.

The external wrap may be a flexible packaging that provides further support for the undergarment, preventing it from bulging and sliding off the internal support. The external wrap may be sized to snuggly receive the internal support. The wrap may be flexible and provide a sanitary packaging to maintain cleanliness of the packaged items.

The internal support and external wrap may be used for a single item or multiple items using one or several internal flexible flat supports and one or several external wrappers. Multiple underpants may be wrapped around a single internal support, which is inserted into an external wrapper for delivery.

Multiple number of underpants, each supported by a single internal support, and wrapped by a single external polybag may be inserted into a single envelope for delivery. Multiple undergarments may be packaged with successive items in an inverted position with respect to one another to even out the items within the external wrap.

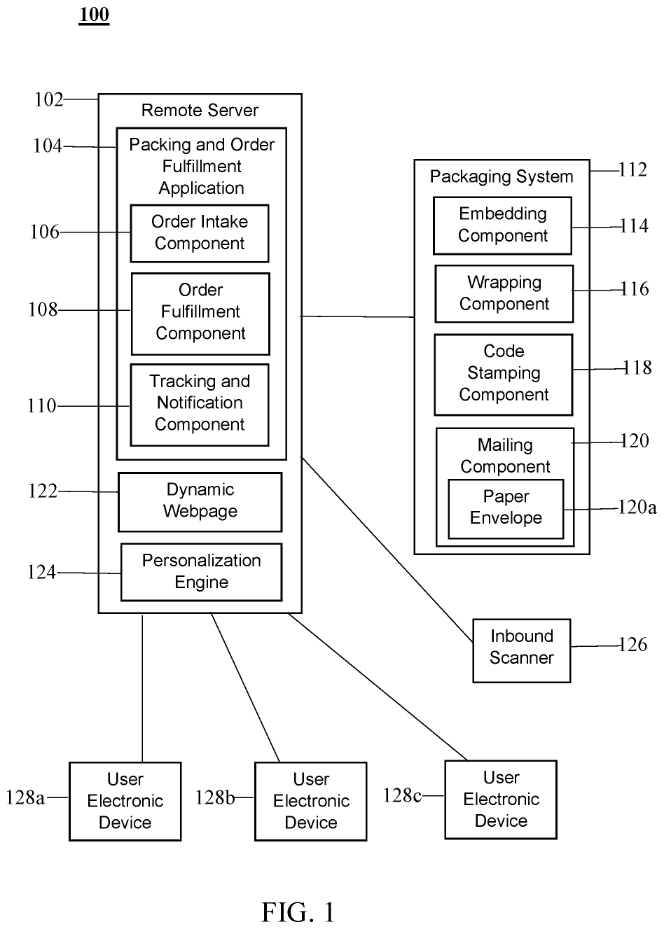

Turning to the figures, FIG. 1 is a block diagram of an undergarment packaging and order fulfillment system according to an embodiment of the present disclosure herein. FIG. 1 depicts components and interactions of a system 100 of undergarment packing and order fulfillment according to an embodiment of the present disclosure.

The system 100 comprises a remote server 102 and a packing and order fulfillment application 104 executing thereon. The remote server 102 and the packing and order fulfillment application 104 may be referred to hereinafter for brevity as the server 102 and the application 104, respectively.

The server 102 may be a single computer or multiple computers situated at a single or multiple physical locations. The application 104 comprises multiple software components that execute on single or multiple instances of the server 102.

The application 104 comprises an order intake component 106, an order fulfillment component 108, and a tracking and notification component 110. Associated with the remote server 102 is a packaging system 112 that comprises mechanical and electronic components for packaging and shipping undergarments. The components comprise an embedding component 114 that embeds the cardboard support into the undergarment and folds the undergarment around the support.

The components also comprise a wrapping component 116 that snugly inserts the undergarment with cardboard support into a sealable bag. The components also comprise a code stamping component 118 for stamping a QR code or barcode onto the sealable bag and the paper envelope.

The components also comprise a mailing component 120 that affixes postage for flat envelope mailing. The shipping label is stamped on a paper envelope 120a into which the sealable bag is placed. Aspects of operations of the packaging system 112 may be performed manually.

The system 100 also comprises a dynamic web page 122 that may execute at least partially on the remote server 102 for customers to access when contacting the remote server 122 for status of order or for alterations, cancellations, or other actions regarding their orders. The system 100 also comprises a personalization engine 124 also executing at least partially on the server 102 that enables customers to respond to personalization surveys and configure preferences for how their order should be fulfilled and shipped. The system 100 also comprises an inbound scanner 126 associated with the server 102 that assists with inbound organization and auditing of packaged items.

The system 100 also comprises multiple user electronic devices 128a-c in the possession of customers to place online orders, check order status, and execute other instructions or requests associated with their orders for undergarments. The user electronic devices 128a-c may be mobile devices that are smart phones and may be equipped with functionality to scan and read bar codes and QR codes.

Barcodes or QR codes are created at two stages. First in a packaging stage when placed on wrapper and used later in lean inbound of merchandise. Second in a fulfillment stage when placed on the shipping label and scanned throughout different fulfillment steps to send update notifications to customers. The first barcode can also be scanned by the customer upon receiving their shipment to get information about the undergarments. The second barcode can be scanned off the shipping label to review the service, rate the received undergarments, return the received undergarments or update preferences.

The system 100 may provide tracking notifications to the consumer (which may be during any and all steps of the fulfillment flow), via the user electronic device 128a-c that enables access to the Internet via browser and may further enable user quick interaction via the user electronic device 128a-c.

The system may provide customers with real time updates/notifications. These may be provided to customers as their order passes the different fulfillment stages.

A fulfillment scanner (not shown in FIG. 1) may trigger an instant fulfillment notification to customers when their respective order is scanned throughout the various fulfillment steps. Many low-cost shipping methods don't provide a shipment tracking number. Such a solution may be utilized as an alternative to conventional shipment tracking numbers. The structure described herein therefore provides significant advantages.

The personalization engine 124 may provide a personalization quiz in which customers may fill a preference survey. The personalization engine 124 may be configured to produce a batch of personalized customer orders using multi-variable optimization over customer preferences, stock availability, shipping method and customer purchase history. This process helps reduce merchandise returns and waste contributing further towards a more sustainable and low-cost business model.

The system 100 includes the application 104 with its order intake component 106, order fulfillment component 108, a tracking and notification component 110 together providing a logistics system in communication with the personalization engine 124. The inbound scanner 126 helps the inbound, organization and auditing of the packaged items. The logistics system provided by the application 104 and its components may be configured to provide an efficient sequence to fulfill orders that minimizes fulfillment time based on assigned products of the personalization engine 124.

Additionally, the disclosed tracking and notification component 110 is configured to provide tracking solutions in communication with other components of the system 100. In an embodiment, a customer may place an order online via a subscription (which may utilize a preference survey), or an add-on or one time order. The order may then be fulfilled and notifications of various steps of the fulfillment flow may be automatically sent to the customer via their electronic device.

The system 100 may allow shipping one or more undergarment items in a single order. For example, multiple items of various styles may be stacked in inverted positions with respect to one another. The flexible flat internal cardboard support of the packaging system enables the undergarments to qualify for shipment as letter mail under USPS DMM 101 letter mailing standards.

The flexible external wrapping of the packaging system provides further support for the undergarment, preventing it from bulging and sliding off the support. The external wrapper of the packaging system also provides sanitization to keep the underpants neat and clean.

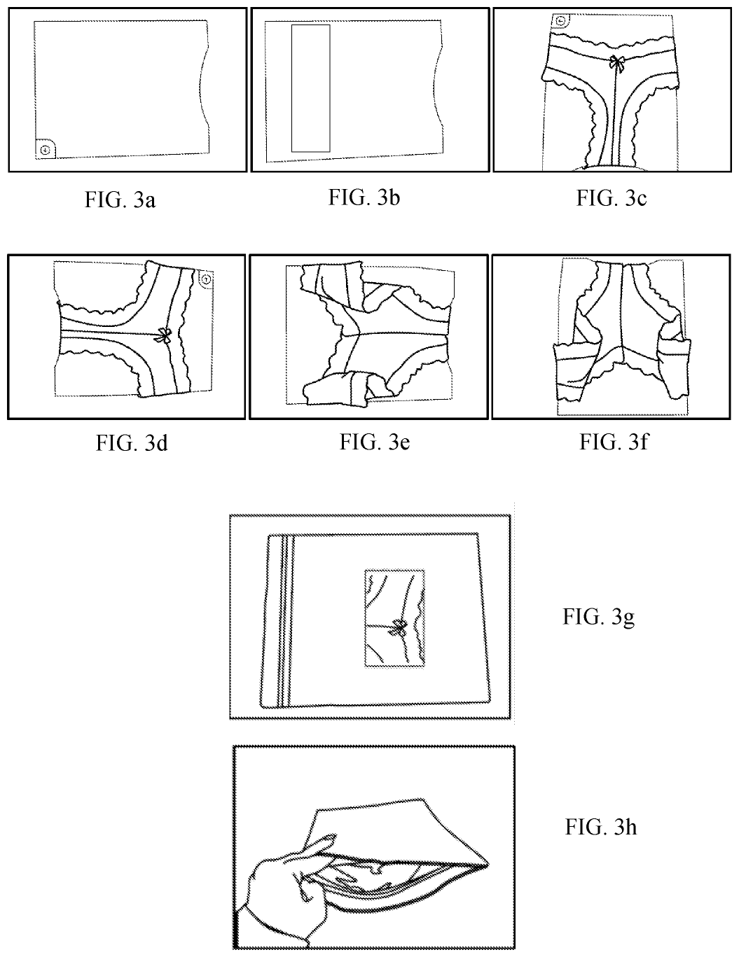

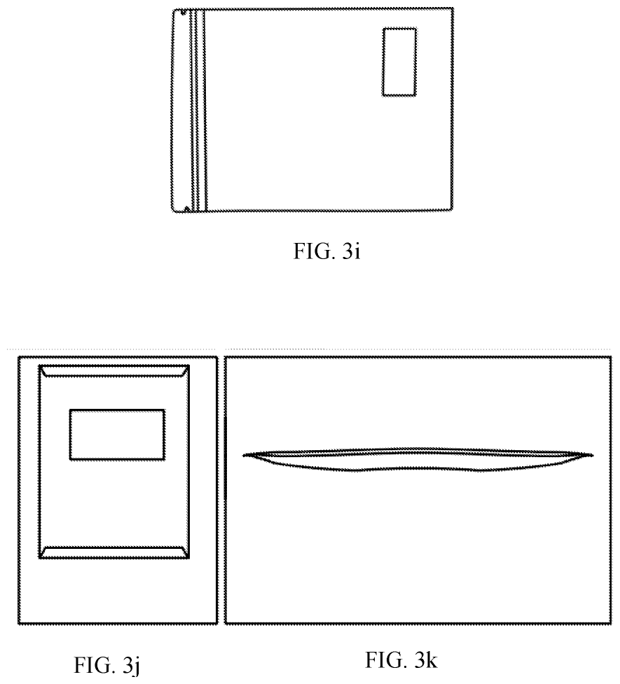

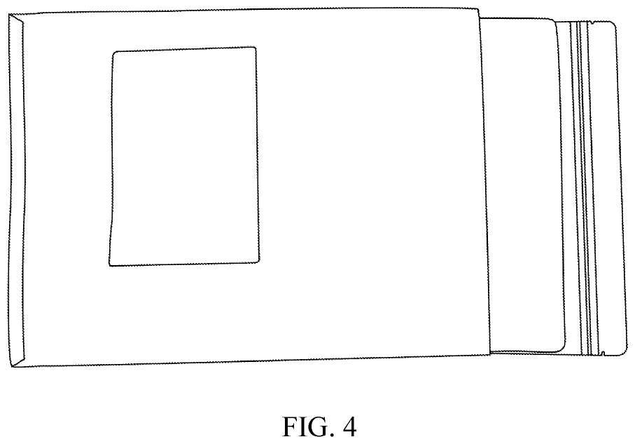

FIG. 3a through FIG. 3l illustrate various aspects of packaging of undergarments as provided herein. FIG. 3a is an image of a flexible support that may be constructed of cardboard. FIG. 3b is an image of a reverse side of the flexible support that may display printed offers and brand material on the surface of the reverse side. FIG. 3c illustrates the flexible support and the undergarment with a semi-circular void in support to hold the undergarment in place.

FIG. 3d, FIG. 3e, and FIG. 3f show the support and the undergarment with the undergarment at various stages of attachment to the support. FIG. 3g is a view of the external wrapper used by the system 100. In embodiments, the wrapper might include a see-through area to show the underpants fabric without the need to open the package. The see-through area or window is shown in FIG. 3g.

FIG. 3h is another view of the external wrapper showing the folded goods inside. The wrapper is optionally resealable. FIG. 3i is another view of the sealed wrapper showing the optional barcode used for lean inbound.

FIG. 3j is an image of the paper envelope that contains the undergarment. FIG. 3j is the image of the sealed paper envelope front side with a shipping label affixed to it. FIG. 3k is the image of sealed paper envelope side view to display thickness.

FIG. 4 is another image of the paper envelope with the shipping label after it is made ready for shipping, but it is not sealed. The label can have the barcode or QR code on it so a customer, upon receipt of the package, may, with his/her user electronic devices 128a, scan the barcode or QR code, reach the remote server 102 and get information or execute instructions. FIG. 4 illustrates how the polybags wrappers may be stacked in it in an inverted position to minimize bulging.

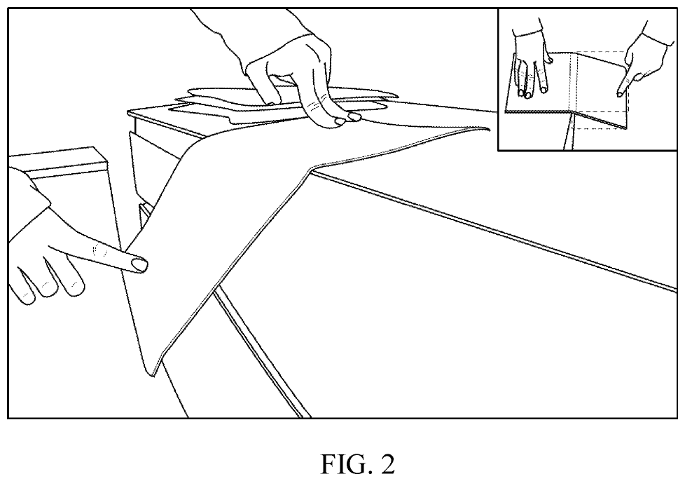

The shipping package of FIG. 3j and FIG. 4 as described herein satisfies the flexibility requirements of low-cost machinable mail as per the USPS DMM 101 standards that requires a min of 2″ perpendicular flexibility measured at the end of the package when bent as shown in FIG. 2.

The present disclosure thus provides a comprehensive efficient and low-cost system for the online sale of undergarments, which may be efficiently mass fulfilled and mailed under the cost-effective machinable letter shipping category compared to traditional expensive parcel shipping methods. Systems and methods provided herein make the consumption of non-bulk underpants online economically viable by significantly reducing fulfillment and shipping costs.

Systems and methods also provide a personalized, lean and cost-effective fulfillment flow, an optimized method of underpants order fulfillment, and an order tracking solution for personalized underpants subscription orders. Further advantages of the disclosed system may include maximizing warehouse storage space and increasing the ease of order picking during the fulfillment process. The combined machinability of the package provided herein with the lean process offered by the logistics system provided herein may significantly reduce the cost of fulfillment and shipping and enable online retailers to sell undergarments at an affordable and competitive price without sacrificing the quality of service offered. The personalization engine described above may also support efforts in reducing waste and in reducing returns of items.

In an embodiment, a system for undergarment packaging and order fulfillment is provided comprising a computer and an application executing on the computer that receives an online order for an undergarment from a mobile device or other electronic device. The system also directs packaging of the online order comprising a flexible flat support component embedded in the undergarment and an external wrapper. The system also ships the undergarment in the wrapper, the wrapper placed inside a paper envelope.

The paper envelope with its contents is shipped as letter mail under USPS DMM 101 letter mailing standards describing Machinable Criteria for Letters/letter shipping. The support component is a cardboard sheet with a rectangular or square shape and a bottom cutout to accommodate a lower part of the undergarment and to hold the undergarment in place, the cutout further comprising a semicircle void centered at a midpoint of a bottom edge.

The packaging is directed to maintaining the support component and undergarment in a flat manner by combining the wrapper into the paper envelope by preferably inverted positions to reduce bulginess, and wherein the shipping label is placed on the paper envelope containing a code. The flat manner of the packaging is directed to compliance with USPS regulations regarding flat package shipping and postage rating.

The paper envelope contains a code scannable by a customer, the code comprising one of a QR code and a barcode. The mobile device subsequently captures an image of the code to activate an inquiry to the computer regarding at least the order. The code is scanned at stages throughout fulfillment, keeping the customer informed, the scanning replacing traditional tracking.

In another embodiment, an online fulfillment and packaging system is provided comprising a computer and an application executing thereon that provides personalization quizzes to a plurality of customers. The system also activates a personalization engine that accesses the stored personalization quizzes and produces a batch of personalized customer orders in accordance with data in the stored quizzes. The system also configures a logistics system to provide a sequence of actions to fulfill the orders that minimizes fulfillment time. The system also provides tracking instructions to the logistics system to assure fulfillment and shipping of the orders.

Data stored in quizzes is referred to as customer preferences data and wherein personalization takes multiple factors into account comprising customer preferences, available inventory, customer ratings, customers reviews and logistical constraints.

The personalization engine produces the batch using multi-variable optimization. The optimization comprises evaluation of at least one of customer preferences, stock availability, shipping method, and customer purchase history. The fulfillment system directs packaging of orders.

The packaging comprises a flexible flat support component embedded in the ordered item, the support component and ordered item sealed inside a plastic wrapper. The packaging further comprises application of one of a barcode and a QR code to a shipping label, wherein the shipping label is affixed on a paper envelope, the paper containing at least one plastic wrapper, the at least one plastic wrapper containing the ordered item(s). Scanning of the QR code assists customers in order rating, preference update and order returns.

In yet another embodiment, a system for undergarment packaging and order fulfillment system is provided. The system comprises a processor, a memory, and a post delivery service application that when executed on the processor stores information associated with a plurality of online orders of undergarments. The system also receives a message containing a QR code, the QR code associated with a first order of the online orders. The system also directs the sender of the message to an online site, locates, based on decoding of the QR code, the first order of the online orders associated with the sender. The system also lists, based at least on the decoding, available actions to the sender via entries to the online site.

The available actions comprise one of requesting reviewing the service, rating the received panties, returning the received panties, or updating preferences. The QR code is created when a shipping label is created for the order. The QR code is affixed to the shipping label and the shipping label is affixed to a paper envelope containing a plastic wrapper that contains merchandise associated with the first order.

What is claimed is:

1. A system for undergarment packaging and order fulfillment, comprising:
a computer, and
an application executing on the computer that:
receives an online order for an undergarment from a mobile device or other electronic device,
directs packaging of the online order comprising:
a flexible flat support component embedded in the undergarment, and
an external wrapper, and
ships the undergarment in the wrapper, the wrapper placed inside a paper envelope.

2. The system of claim 1, wherein the paper envelope with its contents is shipped as letter mail under USPS DMM 101 letter mailing standards describing Machinable Criteria for Letters/letter shipping.

3. The system of claim 1, wherein the support component is a cardboard sheet with a rectangular or square shape and a bottom cutout to accommodate a lower part of the undergarment and to hold the undergarment in place, the cutout further comprising a semicircle void centered at a midpoint of a bottom edge.

4. The system of claim 1, wherein the packaging is directed to maintaining the support component and undergarment in a flat manner by combining the wrapper into the paper envelope by preferably inverted positions to reduce bulginess, and wherein the shipping label is placed on the paper envelope containing a code.

5. The system of claim 7, wherein the flat manner of the packaging is directed to compliance with USPS regulations regarding flat package shipping and postage rating.

6. The system of claim 4, wherein the paper envelope contains a code scannable by a customer, the code comprising one of a QR code and a barcode.

7. The system of claim 1, wherein the mobile device subsequently captures an image of the code to activate an inquiry to the computer regarding at least the order.

8. The system of claim 1, wherein the code is scanned at stages throughout fulfillment, keeping the customer informed, the scanning replacing traditional tracking.

9. An online fulfillment and packaging system comprising:
a computer and an application executing thereon that:
provides personalization quizzes to a plurality of customers,
activates a personalization engine that accesses the stored personalization quizzes,
produces a batch of personalized customer orders in accordance with data in the stored quizzes,
configures a logistics system to provide a sequence of actions to fulfill the orders that minimizes fulfillment time, and
provides tracking instructions to the logistics system to assure fulfillment and shipping of the orders

10. The system of claim 9, wherein data stored in quizzes is referred to as customer preferences data and wherein personalization takes multiple factors into account comprising customer preferences, available inventory, customer ratings, customers reviews and logistical constraints.

11. The system of claim 9, wherein the personalization engine produces the batch using multi-variable optimization.

12. The system of claim 11, wherein the optimization comprises evaluation of at least one of customer preferences, stock availability, shipping method, and customer purchase history.

13. The system of claim 9, wherein the fulfillment system directs packaging of orders.

14. The system of claim 13, wherein the packaging comprises a flexible flat support component embedded in the ordered item, the support component and ordered item sealed inside a plastic wrapper.

15. The system of claim 14, wherein the packaging further comprises application of one of a barcode and a QR code to a shipping label, wherein the shipping label is affixed on a paper envelope, the paper containing at least one plastic wrapper, the at least one plastic wrapper containing the ordered item(s).

16. The system of claim 15, wherein scanning of the QR code assists customers in order rating, preference update and order returns.

17. A system for undergarment packaging and order fulfillment system comprising:
a processor;
a memory; and
a post delivery service application that when executed on the processor:
stores information associated with a plurality of online orders of undergarments,
receives a message containing a QR code, the QR code associated with a first order of the online orders,
directs the sender of the message to an online site,
locates, based on decoding of the QR code, the first order of the online orders associated with the sender, and
lists, based at least on the decoding, available actions to the sender via entries to the online site.

18. The system of claim 17, wherein the available actions comprise one of requesting reviewing the service, rating the received panties, returning the received panties, or updating preferences.

19. The system of claim 17, wherein the QR code is created when a shipping label is created for the order.

20. The system of claim 17, wherein the QR code is affixed to the shipping label and the shipping label is affixed to a paper envelope containing a plastic wrapper that contains merchandise associated with the first order.
